(19) United States
(12) Patent Application Publication
(10) Pub. No.: US 2016/0044207 A1
(43) Pub. Date: Feb. 11, 2016

(54) IMAGE FORMING APPARATUS, IMAGE FORMING METHOD, AND NON-TRANSITORY RECORDING MEDIUM

(71) Applicant: Ryo KOBAYASHI, Kanagawa (JP)

(72) Inventor: Ryo KOBAYASHI, Kanagawa (JP)

(73) Assignee: RICOH COMPANY, LTD., Tokyo (JP)

(21) Appl. No.: 14/810,585

(22) Filed: Jul. 28, 2015

(30) Foreign Application Priority Data
Aug. 5, 2014 (JP) 2014-159821
Jun. 24, 2015 (JP) 2015-126441

(51) Int. Cl. H04N 1/407; H04N 1/00; G06K 15/02

(52) U.S. Cl. CPC H04N 1/4078; G06K 15/027; G06K 15/1822; H04N 1/00068; H04N 1/00087; H04N 2201/0094

(57) ABSTRACT

An image forming apparatus is provided. The image forming apparatus includes a pattern image forming device, a density information detector, and a gradation correction amount calculator. The pattern image forming device forms a pattern image for use in gradation correction on a recording medium. The density information detector detects density information from the recording medium on which the pattern image is formed by the pattern image forming device. The gradation correction amount calculator calculates a gradation correction amount using the density information detected by the density information detector and a feedback rate in accordance with differences among two or more density adjustment modes.

### CROSS-REFERENCE TO RELATED APPLICATIONS

This patent application is based on and claims priority pursuant to 35 U.S.C. §119(a) to Japanese Patent Application Nos. 2014-159821 and 2015-126441, filed on Aug. 5, 2014 and Jun. 24, 2015, respectively, in the Japan Patent Office, the entire disclosure of each of which is hereby incorporated by reference herein.

### BACKGROUND

1. Technical Field

The present disclosure relates to an image forming apparatus, an image forming method, and a non-transitory recording medium.

2. Description of the Related Art

It is known that image forming apparatuses, such as laser printer and MFP (Multi Function Printer), output images with variation due to their temporal change or individual difference. One reason for the variation in output images is fluctuations in dot gain that is caused by temporal change of the apparatus.

The degree of density change caused by the fluctuations in dot gain depends on the number and shape of dither. Therefore, an apparatus having multiple dither patterns should be subjected to calibration multiple times. The multiple times of calibration disadvantageously requires a large amount of time.

### SUMMARY

In accordance with some embodiments of the present invention, an image forming apparatus is provided. The image forming apparatus includes a pattern image forming device, a density information detector, and a gradation correction amount calculator. The pattern image forming device forms a pattern image for use in gradation correction on a recording medium. The density information detector detects density information from the recording medium on which the pattern image is formed by the pattern image forming device. The gradation correction amount calculator calculates a gradation correction amount using the density information detected by the density information detector and a feedback rate in accordance with differences among two or more density adjustment modes.

In accordance with some embodiments of the present invention, an image forming method is provided. The image forming method includes the steps of forming a pattern image for use in gradation correction on a recording medium; detecting density information from the recording medium on which the pattern image is formed; storing the density information in a memory; and calculating a gradation correction amount using the density information stored in the memory and a feedback rate in accordance with differences among two or more density adjustment modes.

In accordance with some embodiments of the present invention, a non-transitory recording medium is provided. The non-transitory recording medium stores a plurality of instructions which, when executed by one or more processors, cause the processors to perform a method including the steps of: forming a pattern image for use in gradation correction on a recording medium; detecting density information from the recording medium on which the pattern image is formed; storing the density information in a memory; and calculating a gradation correction amount using the density information stored in the memory and a feedback rate in accordance with differences among two or more density adjustment modes.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram of a hardware configuration of an image forming apparatus according to an embodiment of the present invention;

FIG. 2 is a schematic diagram of a software configuration of the image forming apparatus according to an embodiment of the present invention;

FIG. 3 is a schematic diagram of a software configuration of the image processing controller according to an embodiment of the present invention;

FIG. 4 is a schematic view of an example of a gradation correction sheet according to an embodiment of the present invention;

FIG. 5 is a graph for explaining a gradation correction operation according to some embodiments of the present invention;

FIG. 6 is a graph for explaining a gradation correction operation according to some embodiments of the present invention, in accordance with screen ruling;

FIG. 7 is a graph for explaining a gradation correction operation according to some embodiments of the present invention, in accordance with screen pattern;

FIG. 8 is a graph for explaining a gradation correction operation according to some embodiments of the present invention, in accordance with input gradation value;

FIG. 9 is a graph for explaining a gradation correction operation according to some embodiments of the present invention, in accordance with input gradation value; and

FIG. 10 is a flowchart illustrating an operation of gradation correction according to some embodiments of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Image forming apparatuses in accordance with some embodiments of the present invention preferably have at least copy function, image forming (e.g., printing) function, and scanner function. These functions in accordance with some embodiments of the present invention may be applicable not only to image forming apparatuses such as printer but also to multifunction printers (MFP) such as copier and facsimile machine.

In accordance with some embodiments of the present invention, an image forming apparatus which can shorten a time required for calibration is provided.

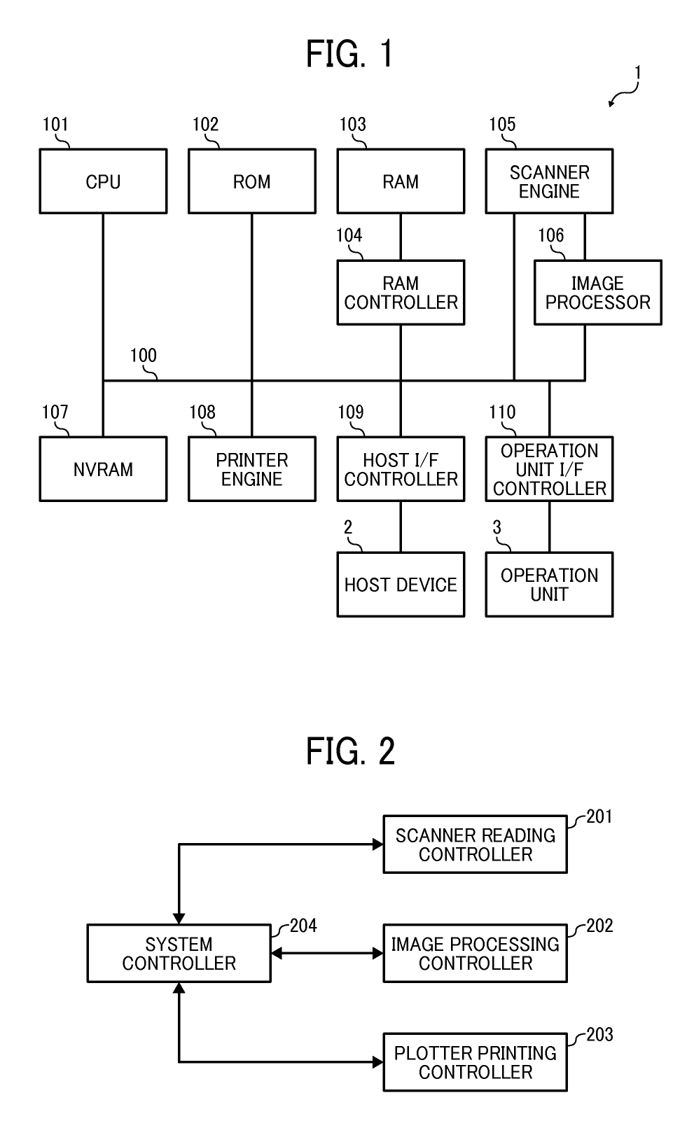

FIG. 1 is a schematic diagram of a hardware configuration of an image forming apparatus according to an embodiment of the present invention. An image forming apparatus 1 includes a bus 100, a CPU (Central Processing Unit) 101, a ROM (Read Only Memory) 102, a RAM (Random Access Memory) 103, a RAM controller 104, a scanner engine 105, an image processor 106, and an NVRAM (Non-volatile Random Access Memory) 107. The image forming apparatus 1 further includes a printer engine 108, a host I/F controller 109, and an operation unit I/F controller 110.

The CPU 101 gives instructions and controls to each block through the bus 100. Depending on the system in use, it is possible to mount multiple CPUs 101 for improving processing performance. The ROM 102 stores programs to be executed by the CPU 101. The RAM 103 temporarily stores data processed in the CPU 101 or each block in software, to be described later, through the RAM controller 104. The RAM controller 104 controls input and output of data to be temporarily stored in the RAM 103.

The scanner engine 105 is a mechanism for incorporating image data or the like using copy function and scanner function. The image processor 106 appropriately applies a digital signal processing to the data incorporated by the scanner engine 105.

The NVRAM 107 is a non-volatile memory which can be used for, for example, holding device-specific information, such as a counter value for the number of copies. The printer engine 108 is a mechanism for performing printing using various imaging methods, such as laser method, light emitting diode method, and inkjet method.

The host I/F controller 109 receives print data or the like from a host device 2. The type of the interface may be, for example, a local connection such as IEEE (Institute of Electrical and Electronics Engineers) 1284 and USB (Universal Serial Bus) or a network connection such as wired or wireless Ethernet (registered trademark). The host device 2 may be, for example, a personal computer or USB.

The operation unit FP controller 110 is an interface of information input and output through an operation unit 3. The operation unit 3 is a man-machine interface between a machine operator and a display (such as LED or LCD (Liquid Crystal Device) for displaying operation buttons and machine conditions) or speaker. In the present embodiment, the operation unit 3 may be either integrally combined with or independent from the image forming apparatus 1.

FIG. 2 is a schematic diagram of a software configuration of the image forming apparatus 1. The software configuration includes a scanner reading controller 201, an image processing controller 202, a plotter printing controller 203, and a system controller 204.

The scanner reading controller 201 controls the scanner engine 105 illustrated in FIG. 1. The plotter printing controller 203 controls the printer engine 108 illustrated in FIG. 1. The system controller 204 is controlled by the CPU 101 and controls the scanner reading controller 201, the image processing controller 202, and the plotter printing controller 203 each illustrated in FIG. 2.

The image processing controller 202 controls the ROM 102, the NVRAM 107, the image processor 106, and the RAM controller 104 each illustrated in FIG. 1 to form and read a pattern image to be used in ACC (Auto Contrast Correct) and calculates and stores a correction amount. The image processing controller 202 performs gradation correction by software, to be described later.

The image processing controller 202 and the plotter printing controller 203 perform outputting of a gradation correction sheet on which the pattern image to be used in ACC is printed. The scanner reading controller 201 performs reading of the gradation correction sheet.

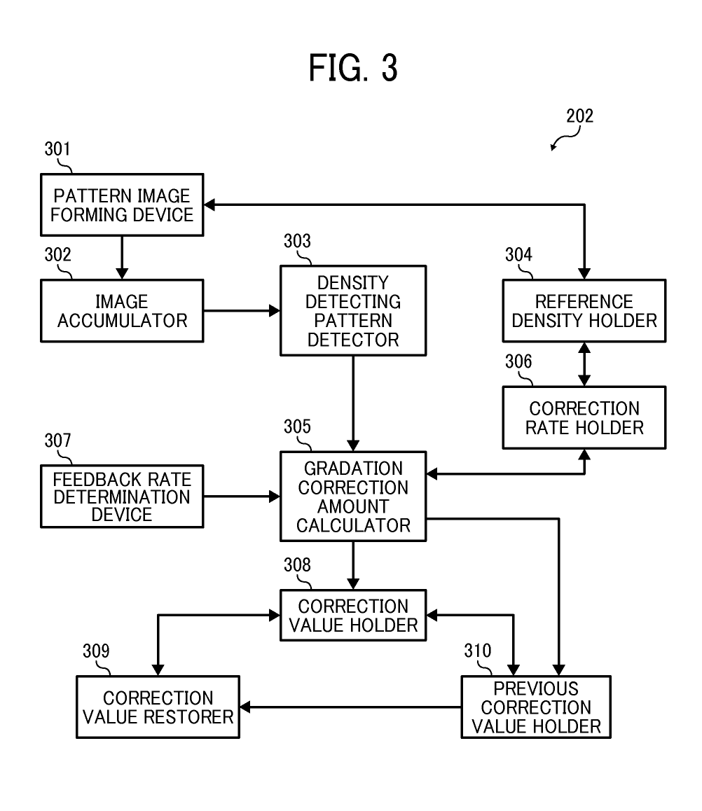

FIG. 3 is a schematic diagram of a software configuration of the image processing controller 202 illustrated in FIG. 2. The image processing controller 202 includes a pattern image forming device 301, an image accumulator 302, a density detecting pattern detector 303, a reference density holder 304, a gradation correction amount calculator 305, and a correction rate holder 306.

The image processing controller 202 further includes a feedback rate determination device 307, a correction value holder 308, a correction value restorer 309, and a previous correction value holder 310.

All the devices illustrated in FIG. 3 are implemented by the instructions of the CPU 101, which are generated according to a program stored in a memory.

The pattern image forming device 301 controls the image processor 106 illustrated in FIG. 1 to form a layout of the pattern image to be used for gradation correction. The image accumulator 302 controls the RAM controller 104 illustrated in FIG. 1 to accumulate images such as the pattern image.

The density detecting pattern detector 303 detects density information by detecting the pattern image from image data obtained by reading the gradation correction sheet. The reference density holder 304 controls the ROM 102 illustrated in FIG. 1 to hold a reference density stored in the ROM that becomes a target of a calibration.

Hereinafter, for the sake of convenience, the density detecting pattern detector 303 and the reference density holder 304 are collectively referred to as a density information detector that detects density information from the recording medium on which the pattern image is formed.

In accordance with an embodiment of the present invention, the gradation correction amount calculator 305 calculates a gradation correction amount using the density information obtained by the density information detector. The gradation correction amount calculator 305 further uses a feedback rate in accordance with differences among two or more density adjustment modes. Details of the two or more density adjustment modes and the feedback rate are described later.

In accordance with an embodiment of the present invention, the gradation correction amount calculator 305 calculates the gradation correction amount further using a difference between reference density information at forming the pattern image and the density information obtained by the density information detector. Details of this processing are described later.

In accordance with an embodiment of the present invention, the gradation correction amount calculator 305 may change the feedback rate in accordance with a screen ruling predetermined in each of the density adjustment modes. Further, the gradation correction amount calculator 305 may change the feedback rate in accordance with a screen pattern used in each of the density adjustment modes. Details of the screen ruling and screen pattern, and this processing are described later.

In accordance with an embodiment of the present invention, the gradation correction amount calculator 305 first calculates a first gradation correction amount in a reference density adjustment mode based on a predetermined feedback rate, then calculates a second gradation correction amount in a changed density adjustment mode, in which screen ruling is changed from that of the reference density adjustment mode, by multiplying the first gradation correction amount by a feedback rate set in the changed density adjustment mode, to calculate the gradation correction amount. Details of this processing are described later.

In accordance with an embodiment of the present invention, the gradation correction amount calculator 305 may calculate the second gradation correction amount in a changed density adjustment mode, in which at least one of screen ruling and screen pattern is changed from that of the reference density adjustment mode, by multiplying the first gradation correction amount by a feedback rate set in the changed density adjustment mode, to calculate the gradation correction amount. Details of this processing are described later.

The correction rate holder 306 stores correction rates to be used in the calibration for each screen held by the image forming apparatus 1.

The correction value holder 308 controls the NVRAM 107 to perform acquisition and storing of a correction value to be used in the image forming apparatus 1. The correction value restorer 309 controls the NVRAM 107 to restore the present correction value to its previous correction value. The previous correction value holder 310 controls the NVRAM 107 to perform acquisition and storing of a correction value for the image forming apparatus 1 before performing ACC.

The feedback rate determination device 307 determines a feedback rate to be used in the gradation correction amount calculator 305. Details of the feedback rate determination processing are described later.

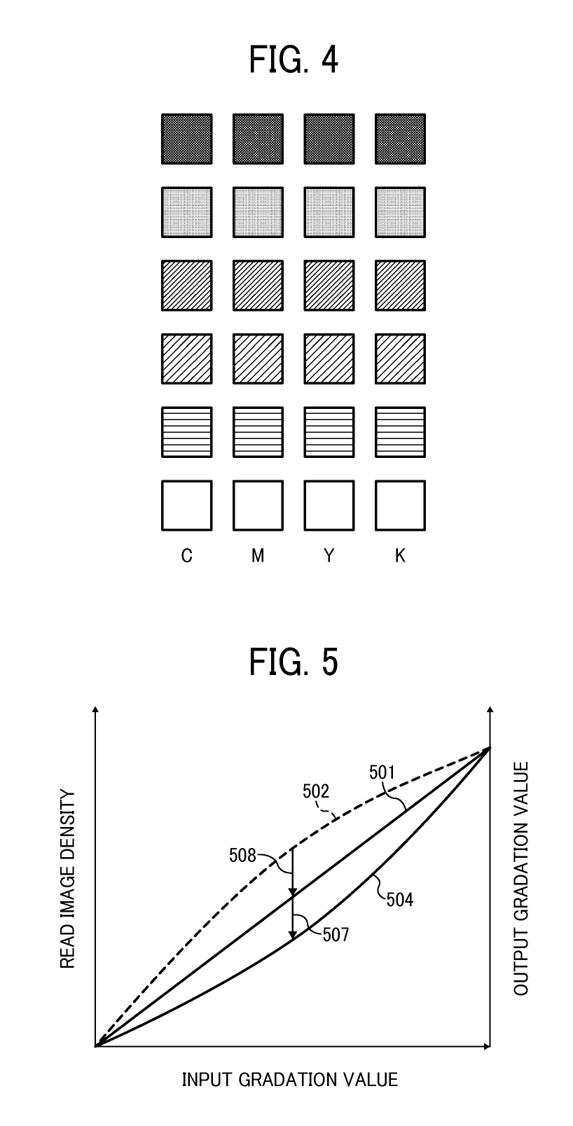

FIG. 4 shows an example of the pattern image for use in the image forming apparatus 1. The pattern image is used for obtaining density information necessary for gradation correction. The pattern image is output by the image forming apparatus 1 to be calibrated. The density detecting pattern detector 303 reads the output pattern image and holds density information on the image forming apparatus 1 to be calibrated. In the present embodiment, the same pattern image is used for the calibration in all print modes.

FIG. 5 is a graph for explaining a gradation correction operation in accordance with some embodiments of the present invention. In this graph, the horizontal axis denotes input gradation value and the vertical axis denotes read image density and output gradation value. A line segment extending straight from bottom left to top right represents a density value (hereinafter “reference density value 501”) with respect to the gradation of the pattern image to be printed on paper for outputting the gradation correction sheet.

A substantially arc-like dashed line segment bulging out convexly upward from the reference density value 501 represents a density value (hereinafter “detection density value 502”) with respect to the gradation of the pattern image obtained from the gradation correction sheet by reading the gradation correction sheet.

An arrow 508 extending downward from the detection density value 502 to the reference density value 501 represents a density difference between the reference density value 501 and the detection density value 502. In the present embodiment, the gradation correction calculator 305 calculates a gradation correction amount based on the density difference 508.

An arrow 507 extending downward from the reference density value 501 represents a gradation correction amount. A substantially arc-like line segment bulging out convexly downward from the reference density value 501 represents a correction γ 504 when the feedback rate in the gradation correction amount calculator 305 is 100%. In the present embodiment, the correction γ 504 is generated by calculating a gradation correction amount for all the input gradation values. The application of the correction γ 504 makes it possible to make prints at a constant density without depending on the density condition of the image forming apparatus 1.

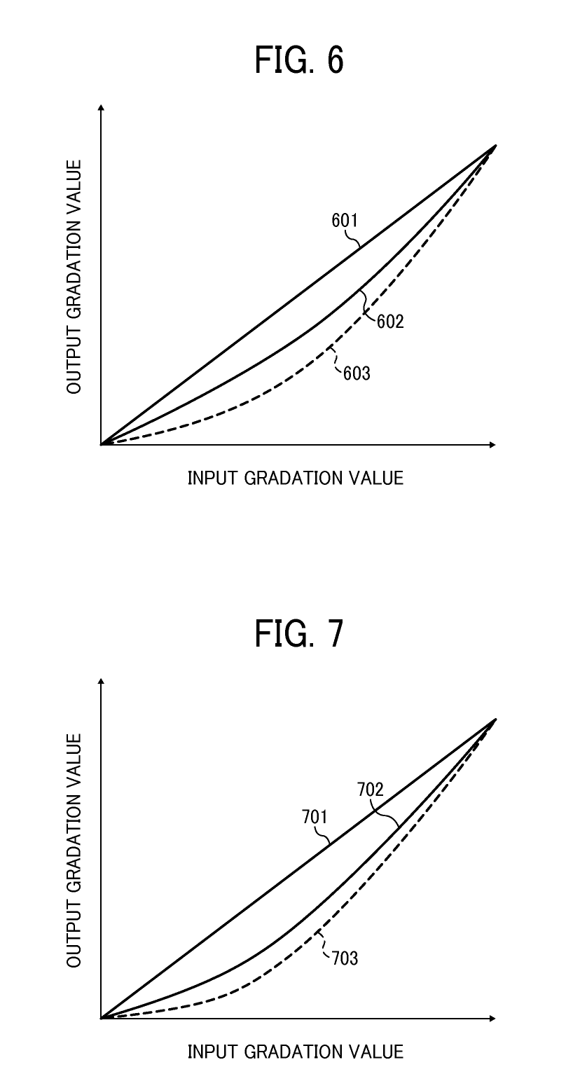

Details of the two or more density adjustment modes and the feedback rate are explained with reference to FIG. 6 and Table 1 below. The density adjustment mode is defined as a concept including, for example, a print mode in a printer, for the sake of convenience.

TABLE 1

| | 190-Line Line Screen | | |
|---|---|---|---|
| | (Reference Density | 175-Line | 150-Line Line |
| Print Mode | Adjustment Mode) | Line Screen | Screen |
| Correction IAW | 0% | −10% | −20% |
| Screen Ruling | | | |
| Feedback Rate | 100% | 90% | 80% |

Image forming apparatuses such as electrophotographic printer and inkjet printer generally have multiple print modes each different in screen ruling and/or screen pattern.

Different screen rulings and/or screen patterns provide different variability in halftone. It requires a large amount of time for performing calibration in all the multiple print modes since each calibration is performed with a different screen specific to each printing mode.

In the present embodiment, the pattern image is printed in the reference density adjustment mode that is a calibration reference. In another print mode (hereinafter “changed density adjustment mode”, for the sake of convenience), the feedback rate determination device 307 determines a feedback rate for a gradation correction value in accordance with the characteristics of the screen. Accordingly, gradation correction amounts for all the print modes can be determined through single calibration in one print mode.

Table 1 shows examples of determination of the feedback rate that is used for calculation of the gradation correction amount in accordance with screen ruling. In the present embodiment, a print mode “190-line line screen” is set as the reference density adjustment mode. In the present embodiment, it is preferable that a print mode with a high screen ruling, for example, 190 lines, is set as the reference density adjustment mode. It is needless to say that the selection of “190 lines” for the high screen ruling is only for descriptive purposes and the high screen ruling is not limited thereto.

In the “175-line line screen” mode, the correction in accordance with screen ruling is −10% relative to the reference density adjustment mode, and the feedback rate is 90%. In the “150-line line screen” mode, the correction in accordance with screen ruling is −20% relative to the reference density adjustment mode, and the feedback rate is 80%. Each of these print modes represents the changed density adjustment mode.

The correction operation is not limited to such an operation which determines a feedback rate by means of subtraction from the feedback rate in the reference density adjustment mode, and may be an operation which determines a feedback rate by means of multiplication by a value determined in accordance with screen ruling.

Since the reference density adjustment mode is actually used in printing the gradation correction sheet, precise correction can be performed even when the feedback rate is 100%. Generally, the higher screen ruling causes greater density fluctuations, and the lower screen ruling causes smaller density fluctuations. It is preferable that the feedback rate is decreased in dependent modes with a lower screen ruling, as illustrated in Table 1 and FIG. 6, if needed.

In FIG. 6, a line segment extending straight from left bottom to top right represents an output gradation value for an input gradation value without correction. This line segment is hereinafter referred to as a non-correction 601 for the sake of convenience. Each substantially ark-like curve bulging out convexly downward from the non-correction 601 represents a gradation correction amount to which the feedback rate is applied. For descriptive purposes, a gradation correction amount with respect to a screen having a low screen ruling is represented by a solid-line curve 602, and a gradation correction amount with respect to a screen having a high screen ruling is represented by a dashed-line curve 603.

The degree of density fluctuations depends on not only screen ruling but also screen pattern (e.g., line pattern or dot pattern). In view of this, in the present embodiment, it is preferable that the feedback rate determination device 307 determines the feedback rate in accordance with screen pattern, as shown in FIG. 7 and Table 2 below.

TABLE 2

| | Print mode | | | | | |
|---|---|---|---|---|---|---|
| | 190-Line | | | | | |
| | Line Screen | | | | | |
| | (Reference Density | 190-Line | 175-Line | 175-Line | 150-Line | 150-Line |
| | Adjustment Mode) | Dot Screen | Line Screen | Dot Screen | Line Screen | Dot Screen |
| Correction | 0% | 0% | −10% | −10% | −20% | −20% |
| IAW Screen | | | | | | |
| Ruling | | | | | | |
| Correction | 0% | −10% | 0% | −10% | 0% | −10% |
| IAW Screen | | | | | | |
| Pattern | | | | | | |
| Feedback | 100% | 90% | 90% | 80% | 80% | 70% |
| Rate | | | | | | |

It is generally said that density fluctuations in dot patterns are smaller than that in line patterns, depending on the property of the printer engine in use. FIG. 7 and Table 2 show examples of determination of the feedback rate and the gradation correction amount in accordance with screen pattern when a printer engine which causes smaller density fluctuations in dot patterns than in line patterns is used.

Referring to Table 2, the “190-line line screen” mode is set as the reference density adjustment mode as is the case with Table 1. In the “190-line dot screen” mode, the correction in accordance with screen ruling is 0% and the correction in accordance with screen pattern is −10% relative to the reference density adjustment mode, and the feedback rate is 90%. In the “175-line line screen” mode, the correction in accordance with screen ruling is −10% and the correction in accordance with screen pattern is 0% relative to the reference density adjustment mode, and the feedback rate is 90%.

In the “175-line dot screen” mode, the correction in accordance with screen ruling is −10% and the correction in accordance with screen pattern is −10% relative to the reference density adjustment mode, and the feedback rate is 80%.

In the “150-line line screen” mode, the correction in accordance with screen ruling is −20% and the correction in accordance with screen pattern is 0% relative to the reference density adjustment mode, and the feedback rate is 80%. In the “150-line dot screen” mode, the correction in accordance with screen ruling is −20% and the correction in accordance with screen pattern is −10% relative to the reference density adjustment mode, and the feedback rate is 70%.

Thus, it is expected that density fluctuations are much smaller in dot patterns than in line patterns. By setting the feedback rate for dot screens to −10%, an optimum gradation correction value can be selected in accordance with screen pattern. By contrast, when density fluctuations are much smaller in line patterns than in dot patterns, the feedback rate for dot screens may be set to +10%.

In the examples shown in Table 2, the final feedback rate is calculated by adding the correction amounts in accordance with screen ruling and screen pattern. However, the method of determining the final feedback rate is not limited thereto. The final feedback rate may be calculated by multiplying a value determined in accordance with screen ruling and a value determined in accordance with screen pattern by each other.

In FIG. 7, a line segment extending straight from left bottom to top right represents an output gradation value for an input gradation value without correction. This line segment is hereinafter referred to as a non-correction 701 for the sake of convenience. Each substantially ark-like curve bulging out convexly downward from the non-correction 701 represents a gradation correction amount to which the feedback rate is applied. For descriptive purposes, a gradation correction amount with respect to the 190-line dot screen is represented by a solid-line curve 702, and a gradation correction amount with respect to the 190-line line screen is represented by a dashed-line curve 703.

FIG. 7 indicates that the gradation correction amount with respect to the 190-line line screen is greater than the gradation correction amount with respect to the 190-line dot screen.

On the other hand, the range of density fluctuations may vary depending on the type of screen. For example, when a printer engine which is very unstable in isolate dots is used in combination with a screen which uses a lot of isolate dots at low-density portions, the density fluctuations in the low-density portions may be significantly large.

Depending on the design of screen, the range of density fluctuations at low-density portions may be smaller relative to that in the reference screen in which gradation correction is performed. It is also assumed that, depending on the design of screen, the range of density fluctuations at middle-density portions and high-density portions may vary in accordance with the density.

In view of this, in the present embodiment, it is preferable that the feedback rate determination device 307 determines a feedback rate to be used in the gradation correction in accordance with the input gradation value. Thus, it becomes possible to prepare for a case where color stability varies depending on the density, e.g., density fluctuations in low-density portions are small or large, density fluctuations in middle-density portions are small or large, or density fluctuations in high-density portions are small or large.

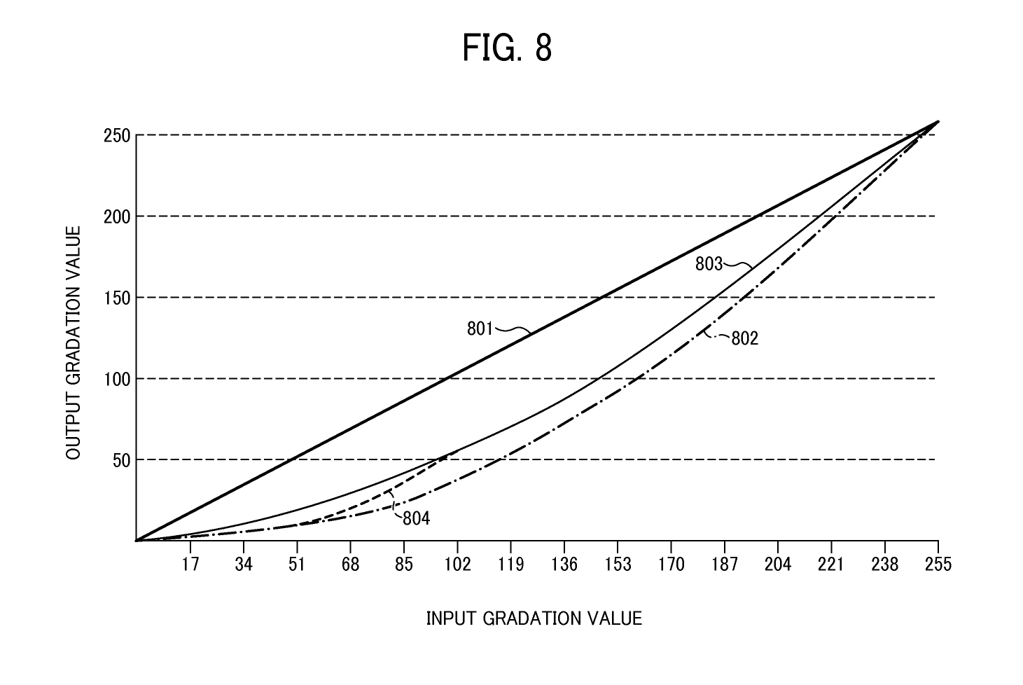

FIG. 8 and Table 3 show examples of determination of the feedback rate and the gradation correction amount when density fluctuations are larger in low-density portions compared to middle-density portions and high-density portions in the screen.

TABLE 3

| | | | | Correction | | | |
|---|---|---|---|---|---|---|---|
| | | Correction | Correction | γ (Variable | | Gradation | Final |
| Gradation | Non- | γ with FB | γ with FB | IAW Grada- | Reference | Correction | FB |
| Value | Correction | Rate 100% | Rate 70% | tion Value) | FB Rate | Amount | Rate |
| 0 | 0 | 0 | 0 | 0 | 70 | 30 | 100 |
| 17 | 17 | 1 | 6 | 1 | 70 | 30 | 100 |
| 34 | 34 | 5 | 14 | 5 | 70 | 30 | 100 |
| 51 | 51 | 10 | 22 | 10 | 70 | 30 | 100 |
| 68 | 68 | 18 | 33 | 23 | 70 | 20 | 90 |
| 85 | 85 | 28 | 45 | 39 | 70 | 10 | 80 |
| 102 | 102 | 41 | 59 | 59 | 70 | 0 | 70 |
| 119 | 119 | 56 | 75 | 75 | 70 | 0 | 70 |
| 136 | 136 | 73 | 92 | 92 | 70 | 0 | 70 |
| 153 | 153 | 92 | 110 | 110 | 70 | 0 | 70 |
| 170 | 170 | 113 | 130 | 130 | 70 | 0 | 70 |
| 187 | 187 | 137 | 152 | 152 | 70 | 0 | 70 |
| 204 | 204 | 163 | 175 | 175 | 70 | 0 | 70 |
| 221 | 221 | 192 | 201 | 201 | 70 | 0 | 70 |
| 238 | 238 | 222 | 227 | 227 | 70 | 0 | 70 |
| 255 | 255 | 255 | 255 | 255 | 70 | 0 | 70 |

In FIG. 8, a thick line segment extending straight from left bottom to top right represents an output gradation value for an input gradation value without correction. This line segment is hereinafter referred to as a non-correction 801 for the sake of convenience. A substantially arc-like dot-and-dash-line curve bulging out convexly downward from the non-correction 801 represents a correction γ 802 when the feedback rate in the gradation correction amount calculator 305 is 100%.

A thin-line curve present between the non-correction 801 and the correction γ 802 represents a correction γ 803 when the feedback rate is 70%. A dashed line represents a correction γ 804 which has been varied according to the input gradation value. Referring to

Table 3, the correction amounts for the gradation values of 17, 34, 51, 68, and 85 in accordance with the correction γ 804 read 1, 5, 10, 23, and 39, respectively. It is clear from FIG. 8 that these correction amounts are smaller than those in accordance with the correction γ 803 when the feedback rate is 70%, i.e., 6, 14, 22, 33, and 45, respectively.

Although the feedback rate determined in accordance with screen ruling and screen pattern is 70%, it is preferable that the feedback rate for low gradation values is re-corrected to be much higher, in view of the fact that density fluctuations are large in low-density portions. Thus, a precise correction can be performed even for a screen which causes large density fluctuations in low-density portions.

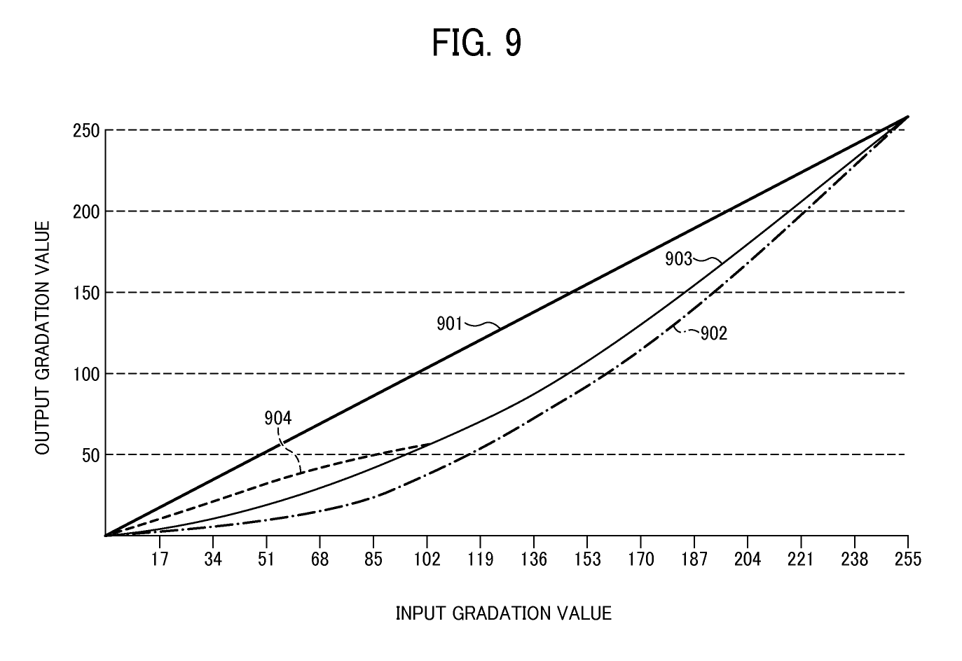

FIG. 9 and Table 4 show examples of determination of the feedback rate and the gradation correction amount when density fluctuations are smaller in low-density portions compared to middle-density portions and high-density portions in the screen.

TABLE 4

| | | | | Correction | | | |
|---|---|---|---|---|---|---|---|
| | | Correction | Correction | γ (Variable | | Gradation | Final |
| Gradation | Non- | γ with FB | γ with FB | IAW Grada- | Reference | Correction | FB |
| Value | Correction | Rate 100% | Rate 70% | tion Value) | FB Rate | Amount | Rate |
| 0 | 0 | 0 | 0 | 0 | 70 | −30 | 40 |
| 17 | 17 | 1 | 6 | 11 | 70 | −30 | 40 |
| 34 | 34 | 5 | 14 | 22 | 70 | −30 | 40 |
| 51 | 51 | 10 | 22 | 35 | 70 | −30 | 40 |
| 68 | 68 | 18 | 33 | 43 | 70 | −20 | 50 |
| 85 | 85 | 28 | 45 | 51 | 70 | −10 | 60 |
| 102 | 102 | 41 | 59 | 59 | 70 | 0 | 70 |
| 119 | 119 | 56 | 75 | 75 | 70 | 0 | 70 |
| 136 | 136 | 73 | 92 | 92 | 70 | 0 | 70 |
| 153 | 153 | 92 | 110 | 110 | 70 | 0 | 70 |
| 170 | 170 | 113 | 130 | 130 | 70 | 0 | 70 |
| 187 | 187 | 137 | 152 | 152 | 70 | 0 | 70 |
| 204 | 204 | 163 | 175 | 175 | 70 | 0 | 70 |
| 221 | 221 | 192 | 201 | 201 | 70 | 0 | 70 |
| 238 | 238 | 222 | 227 | 227 | 70 | 0 | 70 |
| 255 | 255 | 255 | 255 | 255 | 70 | 0 | 70 |

In FIG. 9, a thick line segment extending straight from left bottom to top right represents an output gradation value for an input gradation value without correction. This line segment is hereinafter referred to as a non-correction 901 for the sake of convenience. A substantially arc-like dot-and-dash-line curve bulging out convexly downward from the non-correction 901 represents a correction γ 902 when the feedback rate in the gradation correction amount calculator 305 is 100%.

A thin-line curve present between the non-correction 901 and the correction γ 902 represents a correction γ 903 when the feedback rate is 70%. A dashed line represents a correction γ 904 which has been varied in accordance with the input gradation value.

Referring to Table 4, the correction amounts for the gradation values of 17, 34, 51, 68, and 85 in accordance with the correction γ 904 read 11, 22, 35, 43, and 51, respectively. It is clear from FIG. 9 that these correction amounts are larger than those in accordance with the correction γ 903 when the feedback rate is 70%, i.e., 6, 14, 22, 33, and 45, respectively. Although the feedback rate determined by the feedback rate determination device 307 in accordance with screen ruling and screen pattern is 70%, it is preferable that the feedback rate for low gradation values is re-corrected to be much lower, in view of the fact that density fluctuations are small in low-density portions. Thus, a precise correction can be performed even for a screen which causes small density fluctuations in low-density portions.

In the present embodiment, the gradation correction amount in the changed density adjustment mode is calculated from the following formula.

Gradation Correction Amount (in Changed Density Adjustment Mode)=Gradation Correction Amount (in Reference Density Adjustment Mode)×Feedback Rate/100 (%)

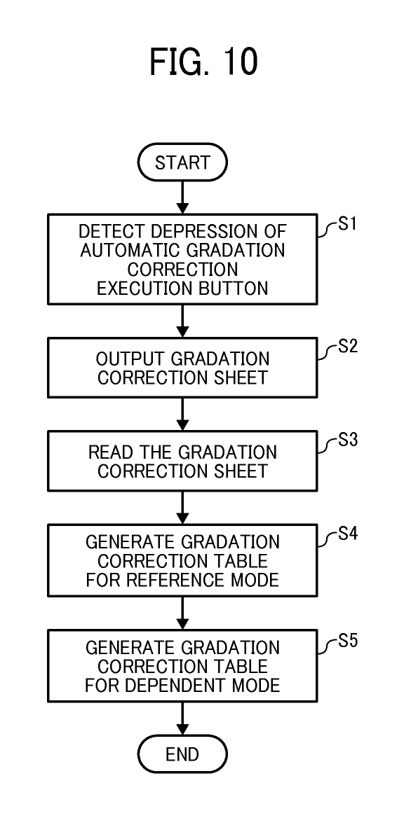

FIG. 10 is a flowchart illustrating an operation of gradation correction in accordance with some embodiments of the present invention. First, an automatic gradation correction button is selected and depressed by a user, for example, through the operation unit 3 (step S1). Next, a gradation correction sheet on which a pattern image is formed is output via the image processing controller 202 and the plotter printing controller 203 (step S2).

The output gradation correction sheet is read via the scanner reading controller 201 by the user (step S3). It is preferable that a screen used when outputting the gradation correction sheet is one of the screens mounted on the printer in use. Hereinafter this screen is referred to as “reference density adjustment screen”.

By reading the gradation correction sheet via the scanner engine 105, the present halftone density characteristics in the reference density adjustment screen can be measured.

A gradation correction table for outputting with the reference density is generated from the difference between the reference density and the present density (step S4).

Here, a screen used in a changed density adjustment mode other than the reference density adjustment mode is referred to as “changed density adjustment screen”. With respect to the changed density adjustment screen, a gradation correction table is generated based on the feedback rate for the screen determined by the feedback rate determination device 307 (step S5). The feedback rate may be set either based on the difference with the reference density adjustment screen in terms of screen ruling and screen pattern, or to different values for each gradation values, as explained referring to FIGS. 6 to 9 and Tables 1 to 4.

With respect to a screen for use in copy function, similarly, it is possible to determine the gradation correction amount based on the difference between the screen used in printing the pattern image and that used in copying.

In the present embodiment, as described above, a calibration pattern common in all print modes is read, and a feedback rate for a correction γ is changed in accordance with screen ruling and screen pattern in each print mode. Thus, all of the multiple print modes can be calibrated by a single calibration operation.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. An image forming apparatus, comprising:
a pattern image forming device to form a pattern image for use in gradation correction on a recording medium;
a density information detector to detect density information from the recording medium on which the pattern image is formed by the pattern image forming device; and
a gradation correction amount calculator to calculate a gradation correction amount using the density information detected by the density information detector and a feedback rate in accordance with differences among two or more density adjustment modes.

2. The image forming apparatus according to claim 1, wherein the gradation correction amount calculator calculates the gradation correction amount further using a difference between reference density information at forming the pattern image by the pattern image forming device and the density information detected by the density information detector.

3. The image forming apparatus according to claim 1, further comprising:
a feedback rate determination device to determine the feedback rate in accordance with screen ruling predetermined in each of the density adjustment modes.

4. The image forming apparatus according to claim 3, wherein the feedback rate determination device determines the feedback rate in accordance with screen pattern used in each of the density adjustment modes.

5. The image forming apparatus according to claim 1, wherein the density adjustment modes include at least:
a reference density adjustment mode based on a predetermined feedback rate; and
a changed density adjustment mode in which at least one of screen ruling and screen pattern is changed from that of the reference density adjustment mode, and
wherein the gradation correction amount calculator calculates the gradation correction amount by multiplying a first gradation correction amount being calculated in the reference density adjustment mode by a feedback rate set in the changed density adjustment mode.

6. The image forming apparatus according to claim 5, wherein the screen ruling in the reference density adjustment mode is a high screen ruling.

7. The image forming apparatus according to claim 3, wherein the feedback rate determination device determines the feedback rate in accordance with an input gradation value.

8. An image forming method, comprising:
forming a pattern image for use in gradation correction on a recording medium;
detecting density information from the recording medium on which the pattern image is formed;
storing the density information in a memory; and
calculating a gradation correction amount using the density information stored in the memory and a feedback rate in accordance with differences among two or more density adjustment modes.

9. A non-transitory recording medium storing a plurality of instructions which, when executed by one or more processors, cause the processors to perform a method, comprising:
forming a pattern image for use in gradation correction on a recording medium;
detecting density information from the recording medium on which the pattern image is formed;
storing the density information in a memory; and
calculating a gradation correction amount using the density information stored in the memory and a feedback rate in accordance with differences among two or more density adjustment modes.
